(19) United States
(12) Patent Application Publication
(10) Pub. No.: US 2002/0056989 A1
(43) Pub. Date: May 16, 2002

(54) MEDICATION I.V. WARNING LABEL

(75) Inventor: SHELLEY LEWIS-LEANDER, KIRKLAND, WA (US)

Correspondence Address: CRAINE ASSOCIATES, INC., 400 112TH AVENUE NE, SUITE 140, BELLEVUE,, WA, 98004

(73) Assignee: lewis-leander

(21) Appl. No.: 09/281,733

(22) Filed: Mar. 30, 1999

Related U.S. Application Data
(60) Provisional application No. 60/080,466, filed on Apr. 2, 1998.

(51) Int. Cl. B42D 15/00

(52) U.S. Cl. 283/81

(57) ABSTRACT

An I.V. medication warning label designed to inform attending healthcare workers of possible medication incompatibility combinations. The label includes a flexible, main label with a front surface and a back surface. The back surface has an adhesive applied thereto which allows the main label to be attached to an I.V. bag or I.V. line. Printed on the front surface of the main label is a primary medication indicator which informs the healthcare worker of the medication contained in the I.V. line or administered through the I.V. line. Also printed on the main label is a list of compatible medications, a list of incompatible medications, a dose calculation information section, a date of administration/mixture, and a plurality of removable tags with the primary medication indicator printed thereon. The removable tags may be detached from the main label and attached to other injection ports or lines located upstream or downstream from the I.V. bag.

This is a Utility Patent Application based on a Provisional Patent Application filed on Apr. 2, 1998 (Serial No. 60/080,466).

### BACKGROUND OF THE INVENTION

1. Field of the Invention

This invention relates to warning labels, and more particularly, to warning labels used to warn healthcare workers of possible medication incompatibility problems associated with commonly administered I.V. medications.

2. Description of the Related Art

It is well known that administering incompatible I.V. drugs or solutions to a patient at the same time can cause undesirable physical or chemical reactions. For example, one drug may inactivate the other or the drugs may interact in a way that harms the patient.

Mixing physically incompatible I.V. drugs can also cause reactions that can interfere with the pharmacological action of one or both drugs. For example, when phenytoin is administered intravenously, it is typically mixed with 0.9% sodium chloride solution. When the phenytoin-saline solution is placed in an I.V. line containing 10% dextrose, a cloudy white precipitate forms which, if infused, can cause pain, thrombophelebitis, or an embolism. To prevent this reaction, the I.V. line must be flushed with 0.9% sodium chloride solution before and after infusing the phenytoin-saline solution.

To prevent I.V. drug incompatibilities, healthcare workers must be aware of which drugs are incompatible and take steps to prevent them from being administered simultaneously or through unflushed I.V. lines or ports. Unfortunately, there are hundreds of different combinations which are difficult to remember. What is needed is an inexpensive warning system designed to assist healthcare workers to reduce the number of I.V. drug incompatibility errors.

### SUMMARY OF THE INVENTION

It is an object of the present invention to provide a warning label designed to be selectively attached to I.V. bags, lines or ports used to administer I.V. medications.

It is another object of the present invention to provide a warning label for commonly administered drugs that lists important compatibility and incompatibility drug combinations.

It is another object of the present invention to provide such a warning label that includes detachable tags that can be attached to other lines or bags connected to the main I.V. line or bag.

It is a further object of the present invention to provide such a warning label that also includes optional dose calculation information and date of administration/mixture.

These and other objects are met by providing an I.V. medication incompatibility warning label designed to inform attending healthcare workers of possible drug incompatibility combinations. The label includes a flexible main label with a front surface and a back surface. The back surface has an adhesive material applied thereto which allows the main label to be selectively attached to an I.V. bag, line or port. Printed on the front surface of the main label is a primary medication indicator means which informs the healthcare worker of the primary medication contained in the I.V. bag or administered through the I.V. line or port. Also printed on the main label is a medication compatibility indicating means, a medication incompatibility indicating means, a manufacturing information indicating means, and at least one detachable label with the name of the primary medication printed thereon. Optional dose calculation formula for the primary medication may also be included. During use, the detachable labels are removed from the main label and attached to other injection ports or lines located upstream or downstream from the I.V. bag, line or port.

### BRIEF DESCRIPTION OF THE DRAWINGS

FIG. 1 is a front elevational view of an I.V. bag and lines hung from an I.V. pole with the main label attached thereto.

FIG. 2 is a front elevational view of the warning label.

FIG. 3 is a top elevational view, in section, of detachable tag wrapped around an I.V. line.

### DESCRIPTION OF THE PREFERRED EMBODIMENT(S)

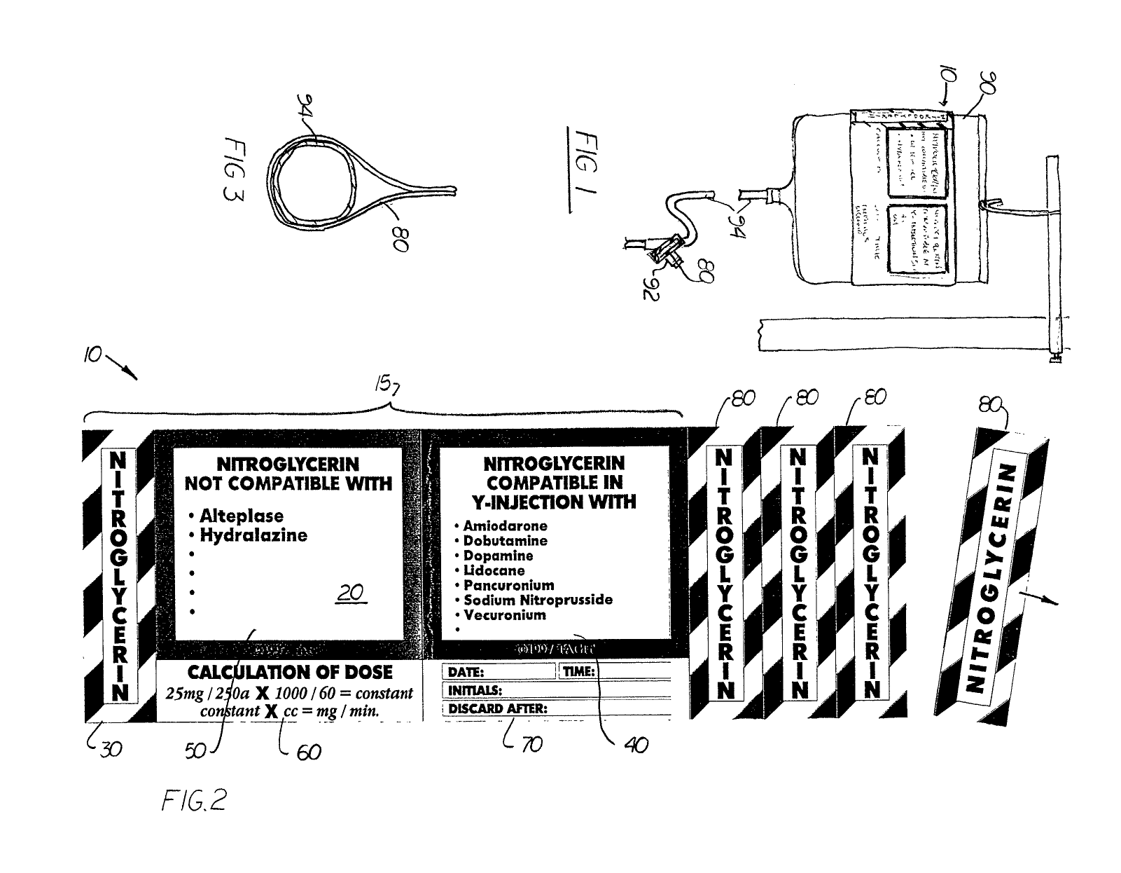

Shown in the accompanying FIGS. 1-3, there is shown an I.V. medication warning label, generally referred to as 10, designed to inform attending healthcare workers of possible medication incompatibility combinations. The warning label 10 includes a flexible main label 15 with a front surface 20 and a back surface 22. The back surface 22 has an adhesive 24 applied thereto which allows the main label 15 to be attached to an I.V. bottle or bag 90. Printed on the front surface 20 of the main label 15 is a primary medication indicator 30 which informs the healthcare worker of the primary or most important medication contained in the I.V. bag 90. Also printed on the main label 15 is a list 40 of compatible medications and a second list 50 of incompatible medications with the primary medication, a dose calculation formula 60, a date of administration/mixture indicator 70, and a plurality of detachable labels 80. The detachable labels 80 have the name of the primary medication printed thereon, which during use, may be removed from the main label 15 and attached to other injection ports 92 or lines 94 located upstream or downstream from the I.V. bag 90.

During use, a warning label 10 with the correct primary medication printed thereon is selected. The date of administration is then indicated and initialed in the administration/mixture section 70. The detachable labels 80 are then removed from the main label 15 and attached to an upstream or downstream I.V. port 92 or line 94. The main label 15 is then attached to the I.V. bag 90 containing the primary medication. The dose of medication to be administered to the patient is then written on the dose calculation formula 60. Later, when other medications are to be administered, the healthcare worker reviews the compatible and incompatible medication lists 40, 50 on the main label 15.

In compliance with the statute, the invention, described herein, has been described in language more or less specific as to structural features. It should be understood, however, the invention is not limited to the specific features shown, since the means and construction shown comprised only the preferred embodiments for putting the invention into effect. The invention is, therefore, claimed in any of its forms or modifications within the legitimate and valid scope of the amended claims, appropriately interpreted in accordance with the doctrine of equivalents.

I claim:

1. A medication I.V. warning label, comprising:
a. a main label with a front surface and a rear surface;
b. an adhesive applied to said rear surface;
c. a primary medication indicator printed on said front surface of said main label;
d. a medication compatibility section on said front surface;
e. a manufacturing information indicating means printed on said front surface; and,
f. at least one detachable label having said primary medication indicator printed thereon.

2. A medication I.V. warning label, as recited in claim 1, wherein said medication compatibility indicating means is a list of medications compatible with said primary medication indicator.

3. A medication I.V. warning label, as recited in claim 1, further including a medication incompatibility indicating means on said front surface.

4. A medication I.V. warning label, as recited in claim 3, wherein said medication incompatibility indicating means is a list of medications incompatible with said primary medication indicator.

5. A medication I.V. warning label, as recited in claim 1, further including a dose calculation formula.
